(19) United States
(12) Patent Application Publication
(10) Pub. No.: US 2007/0039443 A1
(43) Pub. Date: Feb. 22, 2007

(54) Rotary die device

(75) Inventors: Kazuhiko Takahashi, Anpachi-gun (JP); Tsutomu Fukuda, Gifu (JP); Kuniaki Arakawa, Gifu (JP)

Correspondence Address: DARBY & DARBY P.C., P. O. BOX 5257, NEW YORK, NY, 10150-5257, US

(73) Assignee: Mitsubishi Materials Corporation, Tokyo (JP)

(21) Appl. No.: 10/570,282

(22) PCT Filed: Aug. 17, 2004
(86) PCT No.: PCT/JP04/11760

§ 371 Date: Oct. 11, 2006

(30) Foreign Application Priority Data
Aug. 27, 2003 (JP) 2003-209139

(51) Int. Cl. B26D 7/20

(52) U.S. Cl. 83/659

(57) ABSTRACT

A movable unit, a fixed unit, and advance/retreat units are supported by a supporting structure. The supporting structure includes a base plate, a top plate, a front plate, and a rear plate. Between the front plate and the rear plate of the supporting structure, supporters of the movable unit are fixed by bolts, and supporters of the fixed unit are fixed by bolts above the movable unit. This prevents the axes of a fixed unit and a movable unit from being misaligned with each other. In addition, it also prevents looseness from being generated between the both units, thus preventing the life span of blades from being shortened.

### CROSS-REFERENCE TO PRIOR APPLICATION

This is a U.S. National Phase Application under 35 U.S.C. §371 of International Patent Application No. PCT/JP2004/011760 filed Aug. 17, 2004, and claims the benefit of Japanese Patent Application No. 2003-209139 filed Aug. 27, 2003, both of them are incorporated by reference herein. The International Application was published in Japanese on Mar. 10, 2005 as WO 2005/021224 A1 under PCT Article 21(2).

### BACKGROUND OF THE INVENTION

1. Field of the Invention

The present invention relates to a rotary die device, and particularly, to a rotary die device that cuts a workpiece in a desired shape between a pair of rollers rotated in opposite directions to each other.

2. Description of the Related Art

In general, as a cutting device used for processing a sanitary product, it has been known a rotary die device having a fixed unit and a movable unit in which the axes are parallel to each other. The rotary die device cuts a workpiece in a desired shape between rollers of the fixed unit and the movable unit, which are rotated in opposite directions to each other (For example, see JP-A-2002-28898 (pages 3 to 4, FIG. 1)).

As described above, in the conventional rotary die device having the movable unit, columns stand at four corners of a base plate between the base plate and a top plate. Further, advance/retreat units, the movable unit, and the fixed unit are inserted into a space among the four columns from the upper side in this order to be assembled. In addition, when the movable unit is pushed up by driving the advance/retreat units, the roller of the movable unit is pressed against the roller of the fixed unit. In this state, the roller of the movable unit and the roller of the fixed unit cut the workpiece therebetween. Moreover, a plurality of reinforcing members such as cross beams or blocks is provided among the columns to reinforce the columns so that the columns are not deformed.

However, the above-mentioned conventional rotary die device has a structure in which the movable unit and the fixed unit are inserted into the space among the four columns from the upper side to the lower side in this order to be assembled, that is, in which the fixed unit and the movable unit are inserted and removed from the upper side. Accordingly, the conventional rotary die device has some clearances so that the units can move in a direction orthogonal to a direction of inserting and removing the units. For this reason, when the rotary die device is assembled, the movable unit and the fixed unit are not aligned with each other in a direction orthogonal to the inserting direction thereof. As a result, it is difficult to align the axes of both units with each other, and looseness is generated between the both units. Therefore, there has been a problem in that a cutting force is reduced.

In addition, when a driving force of the advance/retreat units is increased to solve the problems due to the clearance and looseness, the pressing force of the movable unit against the fixed unit is improperly increased. As a result, there has been a problem in that the life span of blades formed on the roller is shortened.

### SUMMARY OF THE INVENTION

The invention has been made to solve the above-mentioned problems, and it is an object of the invention to provide a rotary die device that can prevent the axes of a movable unit and a fixed unit from not being aligned with each other, prevent looseness from being generated between the units, and prevent the life span of blades from being shortened, in order to cut a workpiece well.

The invention provides the following device in order to achieve the object. According to a first aspect of the invention, a rotary die device includes each of a fixed unit and a movable unit that has a roller and supporters, both ends of the roller being rotatably supported by the supporters, and the axes of the fixed unit and movable unit being parallel to each other; blades that are formed on one of the rollers of the fixed unit and movable unit; and a supporting structure that supports the fixed unit and the movable unit. Both of the rollers of the fixed unit and movable unit are rotated in opposite directions to each other, respectively, so that a workpiece is cut therebetween in a desired shape. The supporting structure includes a base plate and a top plate which face each other with a predetermined space therebetween, and a front plate and a rear plate which are provided between the base plate and the top plate on the front and rear sides, respectively. The fixed unit and the movable unit are fixed between the front plate and the rear plate.

According to the rotary die device of the invention, the movable unit and the fixed unit come in contact with the rear plate (or the front plate) by using the inner surface thereof as a reference surface during the assembly. Accordingly, it is possible to stably fix the units among the rear plate, the front plate, the top plate, and the base plate as well as to stably fix the units between the rear plate and the front plate. For this reason, it is possible to assemble the entire rotary die device with high accuracy as well as to assemble each unit in the supporting structure with high accuracy. As a result, it is possible to prevent the axes of the fixed unit and the movable unit from not being misaligned with each other and to remove factors causing vibration by removing looseness. In addition, since the units do not need to be pressed against each other, it is possible to increase the life span of the blades and to smoothly cut the workpiece.

According to a second aspect of the invention, the above-mentioned rotary die device according to the first aspect of the invention further includes linear bearings that slidably guide the movable unit toward the fixed unit and are provided between the movable unit, and the front plate and the rear plate; and the advance/retreat units that advance or retreat the movable unit with respect to the fixed unit by the linear bearings and are provided between the movable unit and the front plate, and between the movable unit and the rear plate. Here, the advance/retreat units may be fixed between the front plate and the rear plate, and may be fixed on the top plate or on the lower surface of the base plate.

According to the rotary die device of the invention, the linear bearings are provided between the front plate and the rear plate so that the movable unit is slidably guided. Accordingly, when the movable unit is advanced or retreated with respect to the fixed unit by driving the advance/retreat units, the movable unit can slide without clearance. As a result, the linear bearings, which are mounted on both ends of the movable unit in the axial direction thereof, can smoothly and equally guide the movable unit so as to be synchronized with each other. For this reason, even though the movable unit slides during the advance or retreat of the movable unit, there is no possibility that the axes of the movable unit and the fixed unit are not aligned with each other. Accordingly, it is possible to smoothly adjust the movable unit.

### BRIEF DESCRIPTION OF THE DRAWINGS

FIG. 1 is a plan view showing a state in which a top plate is separated from a rotary die device according to an embodiment of the invention;

FIG. 2 is a front view of a longitudinal cross-sectional view showing the rotary die device;

FIG. 3 is a side view showing the rotary die device; and

FIG. 4 is a perspective view illustrating a movable unit and a fixed unit of the rotary die unit.

### DESCRIPTION OF THE PREFERRED EMBODIMENTS

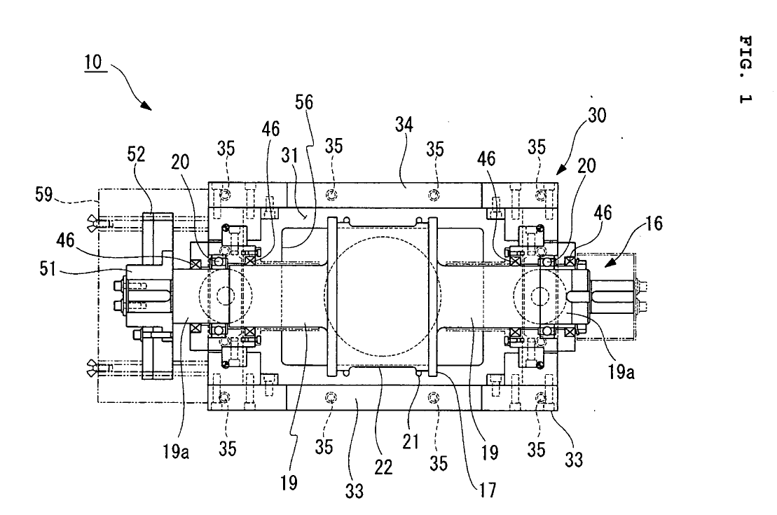

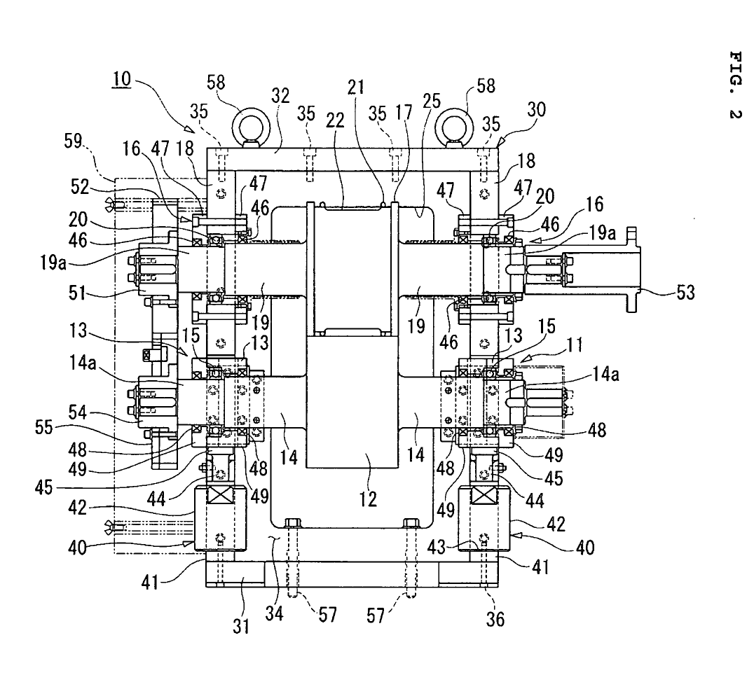

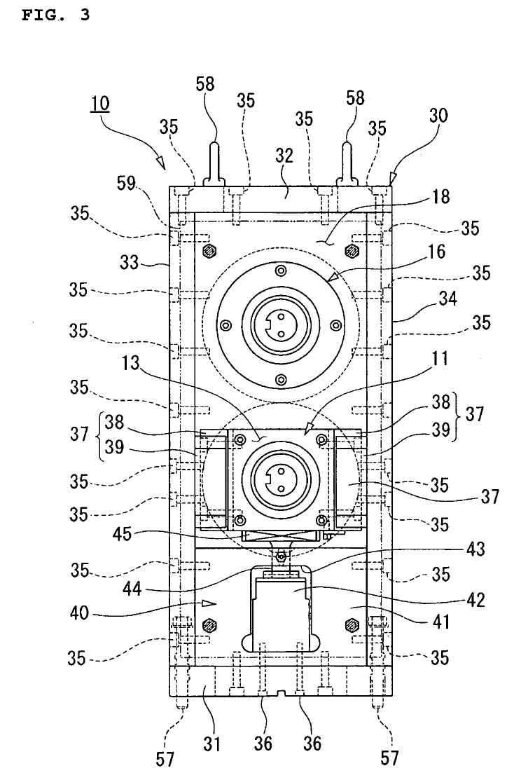

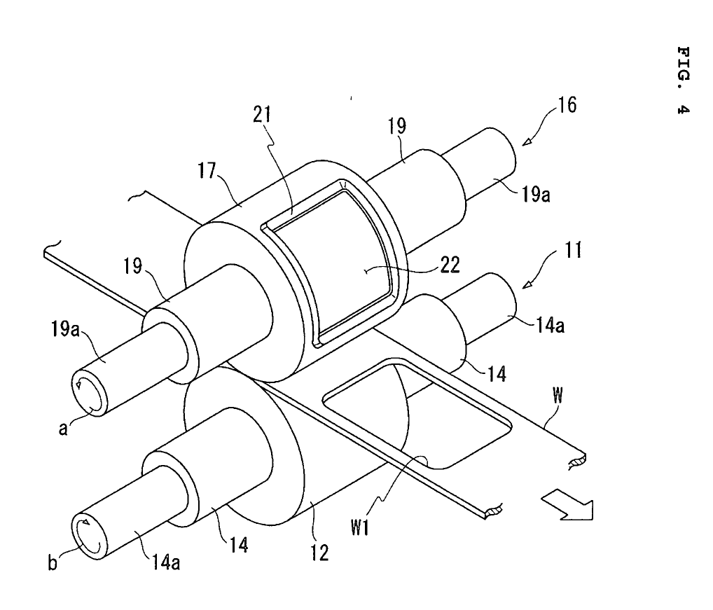

Hereinafter, a preferred embodiment of the invention will be described with reference to the drawings. FIGS. 1 to 4 show a rotary die device according to an embodiment of the invention. FIG. 1 is a plan view showing the rotary die device, FIG. 2 is a front view showing the rotary die device, FIG. 3 is a side view showing the rotary die device, and FIG. 4 is a perspective view illustrating a state in which a movable unit and a fixed unit of the rotary die unit cut a workpiece.

The rotary device 10 shown in FIGS. 1 to 3 includes a movable unit 11 and a fixed unit 16, and an anvil 12 of the movable unit 11 and a die 17 of the fixed unit 16 are rotated in opposite directions to each other, respectively, so that the workpiece is cut therebetween.

As shown in FIG. 2, the movable unit 11 is composed of the anvil 12 and supporters 13. The anvil 12 is a roller, and is rotatably supported by the supporters 13. As shown in FIGS. 2 and 4, the anvil 12 has an appropriate diameter, and shafts 14, which have smaller diameters than a diameter of the anvil, protrude from both sides of the anvil in an axial direction thereof, respectively. Furthermore, a small diameter portion 14a, which has a smaller diameter than that of the shaft, protrudes from the end of each shaft 14. Each of the supporters 13 has a bearing 15 mounted therein. Each small diameter portion 14a of the anvil 12 is rotatably supported by the bearing 15, and each supporter forms a so-called bearing box.

As shown in FIG. 2, the fixed unit 16 is composed of a die 17 and supporters 18. The die 17 is a roller, and is rotatably supported by the supporters 18. As shown in FIGS. 2 and 4, shafts 19, which have smaller diameters than the diameter of the die, protrude from both sides of the die 17 in an axial direction thereof, respectively. Furthermore, a small diameter portion 19a, which has a smaller diameter than that of the shaft, protrudes from the end of each shaft 19. Each of the supporters 18 has a bearing 20 mounted therein. Each small diameter portion 19a of the die 17 is rotatably supported by the bearing 20, and each supporter constitutes a so-called bearing box.

In addition, blades 21 are formed on the periphery of the die 17. As shown in FIG. 4, each pair of blades 21 protrudes from the periphery of the die 17 in an axial direction and a rotation direction of the die 17 so as to be positioned substantially parallel and orthogonal to each other. Accordingly, the blades 21 are formed in the shape of a rectangular window frame. Then, a recess 22 is formed on the inside portion of the blades on the periphery of the die so as to have a lower height than those of the peripheries of the blades 21. In this case, when the die 17 and the anvil 12 are rotated in opposite directions to each other, which are indicated by arrows a and b shown in FIG. 4, respectively, the workpiece W is interposed between the die 17 and the anvil 12, thereby cutting the workpiece W to form a desired shaped portion W1.

The movable unit 11, the fixed unit 16, and advance/retreat units 40 to be described below are supported by a supporting structure 30 to be described below so that axes thereof are parallel to one another. As shown in FIGS. 1 to 3, the supporting structure 30 includes a base plate 31, a top plate 32, a front plate 33, and a rear plate 34. However, since FIG. 1 is a plan view showing a state in which a top plate 32 is separated from a rotary die device, the top plate 32 is not shown in FIG. 1.

The base plate 31 and the top plate 32 face to each other with a predetermined space therebetween. The front plate 33 and the rear plate 34 are provided between the base plate 31 and the top plate 32 so as to be mounted on the front and the rear sides of the supporting structure. Each of the base plate 31, the top plate 32, the front plate 33, and the rear plate 34 is a plate shaped body with an appropriate thickness, both sides thereof are flat. Meanwhile, the base plate 31, the top plate 32, the front plate 33, and the rear plate 34 are fixed to one another by tightening bolts 35, thereby forming the supporting structure 30 in the shape of a rectangular pipe.

As shown in FIG. 3, between the front plate 33 and the rear plate 34 of the supporting structure 30, both sides of the supporters 13 of the movable unit 11 are fixed by bolts 35, and both sides of the supporters 18 of the fixed unit 16 are fixed by bolts 35 above the movable unit. Accordingly, the movable unit 11 is fixed in the same manner as that of the fixed unit 16.

In this case, linear bearings 37 are provided between the front plate 33 and the movable unit 11, and between the rear plate 34 and the movable unit 11. As shown in FIG. 3, each of the linear bearings 37 includes a rail part 38, a block part 39, and balls (not shown) interposed between the rail part 38 and the block part 39. The rail parts 38 are mounted on both sides of each supporter 13 of the movable unit 11, and the block parts 39 are mounted at positions corresponding to the rail parts 38 on the inner surfaces of the front and the rear plates 33 and 34. Since the rail parts 38 slide on the block parts 39 without a clearance by the balls, the movable unit 11 can be advanced or retreated with respect to the fixed unit 16 in the upward and downward directions.

Furthermore, as shown in FIG. 3, between the front plate 33 and the rear plate 34, the advance/retreat units 40 are fixed by bolts 35 below the supporters 13 of the movable unit 11, respectively. As shown in FIGS. 2 and 3, each of the advance/retreat units 40 is composed of a plate shaped body 41 for drive, and a hydraulic cylinder 42 mounted on the plate for drive. In the same manner as those of the above-mentioned movable unit 11 and fixed unit 16, the advance/retreat units 40 are fixed below the supporters 13 between the front plate 33 and the rear plate 34, respectively, by tightening bolts 35 on both sides of each plate shaped body 41 for drive. In addition, the advance/retreat units 40 may be positioned on the top plate 32 or on the lower surface of the base plate 31.

Furthermore, as shown in FIG. 3, in each advance/retreat unit 40, the hydraulic cylinder 42 is mounted in the mounting hole 43 formed in the plate shaped body 41 for drive, and a rod 44 of the hydraulic cylinder 42 is inserted into an insertion hole (reference numeral thereof is not shown) formed in the plate shaped body 41 for drive. Accordingly, when the rod 44 is advanced by driving the hydraulic cylinder 42, a contact plate 45 fixed to the tip of the rod 44 pushes up the supporter 13 of the movable unit 11. When the contact plate 45 descends by retreating the rod 44, the supporter 13 of the movable unit 11 descends. Accordingly, the movable unit 11 can be advanced or retreated with respect to the fixed unit 16.

As shown in FIG. 2, each of the plate shaped bodies 41 for drive has a smaller thickness than that of the supporter 13 of the movable unit 11, and has substantially the same thickness as that of the supporter 18 of the fixed unit 16. In addition, as shown in FIG. 3, the lower end surface of each plate shaped body 41 for drive is fixed to the base plate 31 by bolts 35. As shown in FIGS. 2 and 3, each of the hydraulic cylinders 42 is fixed to the base plate 31 by bolts 36 with the plate shaped body 41 for drive therebetween.

Furthermore, insertion holes (reference numerals thereof are not shown), into which bolts are inserted, are formed at positions corresponding to the bolts 35 on the base plate 31, the top plate 32, the front plate 33, and the rear plate 34 such that the heads of the bolts are buried in the insertion holes. Meanwhile, the supporters 13 of the movable unit 11, the supporters 18 of the fixed unit 16, and the plate shaped bodies 41 for drive of the advance/retreat unit 40 are provided with internal threads (reference numerals thereof are not shown) into which thread portions of the bolts 35 are screwed. The insertion holes, the internal threads, and the bolts 35 are shown by a broken, line.

In addition, the upper end surface of each supporter 18 of the fixed unit 16 is fixed to the top plate 32 by bolts 35. Furthermore, as shown in FIG. 2, each of the front plate 33 and the rear plate 34 is provided with a workpiece inserting hole 25, which is used to insert the workpiece W. However, since FIG. 2 is a longitudinal cross-sectional view, a workpiece inserting hole 25 of the rear plate 34 is not shown.

More specifically, as shown in FIG. 2, in the fixed unit 16, seal supporting parts 47 having seal members 46 are mounted by bolts (reference numerals thereof are not shown) on the outer sides of the supporters 18 in the axial direction, respectively, such that the seal members 46 hermetically seal gaps between the supporting parts 47 and the shafts 19 and between the supporting parts 47 and the small diameter portions 19a of the die 17. Meanwhile, in the movable unit 11, seal supporting parts 49 having seal members 48 are mounted by bolts (reference numerals thereof are not shown) on the outer sides of the supporters 13 in the axial direction thereof, respectively, so that the seal members 48 hermetically seal gaps between the supporting parts 49 and the shafts 14 and between the supporting parts 49 and the small diameter portions 14a of the anvil 12.

In addition, as shown in FIG. 2, a gear 52 is mounted to the left small diameter portion 19a of the die 17 through a hub 51, and a driving shaft 53 connected to a driving source such as a motor (not shown) is connected to the right small diameter portion 19a. Furthermore, a gear 55 engaged with the gear 52 is mounted to the left small diameter portion 14a of the anvil 12 through a hub 54. When the driving shaft 53 is driven by the driving source (not shown) and thus the die 17 of the fixed unit 16 is rotated, the rotational force of the die is transmitted to the small diameter portions 14a of the anvil 12 through the gears 52 and 55. Accordingly, as shown in FIG. 4, the die 17 and the anvil 12 are rotated in opposite directions to each other.

In this case, it goes without saying that the die 17 and the anvil 12 may be rotated and pressed against each other when using another transmitting unit such as a belt other than the gears 52 and 55.

Furthermore, reference numeral 56 in FIG. 1 represents an opening formed in the base plate 31, and reference numerals 57 in FIG. 2 represent mounting bolts used to mount the rotary die device 10. Reference numerals 58 in FIGS. 2 and 3 represent rings used to lift the rotary die device 10, and reference numeral 59 in FIGS. 1 to 3 represent a cover that is shown by a two-dot chain line and surrounds the gears 52 and 55. The cover is mounted to the supporting structure 30 by butterfly nuts and bolts.

The rotary die device 10 according to the embodiment is configured as described above, and can be assembled as described below.

First, the rear plate 34 is put on a jig (not shown) so that pins and the likes implanted in the jig are inserted into the insertion holes of the rear plate 34, thereby horizontally setting the rear plate 34 on the jig. In this case, the base plate 31 is fixed to the lower end surface of the rear plate 34 by bolts 35.

After that, the advance/retreat units 40, the movable unit 11, and the fixed unit 16 are positioned on the rear plate 34, and the front plate 33 is positioned on the units positioned on the rear plate. Then, the plate shaped bodies 41 for drive of the advance/retreat units 40, the supporters 13 of the movable unit 11, and the supporters 18 of the fixed unit 16 are fixed on the inner surface of the front plate 33 by the bolts 35.

Next, the top plate 32 is fixed on the upper end surfaces of the front and rear plates 33 and 34 by the bolts 35. Then, an assembly including the base plate 31, the top plate 32, the front plate 33, and the rear plate 34, is reversed so that the top and bottom of the assembly are reversed. After that, the jig is removed from the assembly. Then, the supporters 18 of the fixed unit 16, the supporters 13 of the movable unit 11, and the plate shaped bodies 41 for drive of the advance/retreat units 40 are fixed to the rear plate 34 by tightening the bolts 35 from the outside of the rear plate 34. The base plate 31, the top plate 32, the front plate 33, and the rear plate 34 are tightly fixed to one another by tightening the bolts. As a result, the supporting structure 30 including the plates 31 to 34 is formed.

However, the top plate 32 may be fixed to the jig in addition to the base plate 31. Further, instead of the rear plate, the front plate 33 34 is set on the jig in advance, and the rear plate may be fixed to the front plate 33 as described above.

After that, the gear 52 is mounted to the small diameter portion 19a of the die 17 of the fixed unit 16, and the gear 55 is mounted to the small diameter portion 14a of the anvil 12 of the movable unit 11. Then, the hydraulic cylinders 42 of the advance/retreat units 40 is driven so that each of the contact plates 45 fixed to the rods 44 pushes up the movable unit 11 toward the fixed unit 16, thereby adjusting the gap between the anvil 12 and the die 17 and aligning the axes thereof. As a result, the rotary die device 10 is configured.

When the rotary die device 10 is configured as described above, each unit of the advance/retreat units 40, the movable unit 11, and the fixed unit 16 comes in contact with the rear plate 34 (or the front plate 33) by using the inner surface thereof as a reference surface during the assembly. Accordingly, it is possible to stably fix the units 40, 11, and 16 among the rear plate 34, the front plate 33, the top plate 32, and the base plate 31 as well as to stably fix the units between the rear plate 34 and the front plate 33.

Therefore, since the units 40, 11, and 16 are fixed by using the inner surface of the rear plate 34 (or the front plate 33) as a reference surface, it is possible to assemble the entire rotary die device 10 with high accuracy as well as to assemble the units 40, 11, and 16 in the supporting structure 30 with high accuracy, and to configure the rotary die device 10 with very high stiffness.

As a result, when being compared to the related art which needs a plurality of parts such as columns mounted at four corners of the base plate, the invention can prevent the axes of the fixed unit 16 and the movable unit 11 from not being aligned with each other and remove factors causing vibration by removing looseness. In addition, since the units 11 and 16 do not need to be pressed against each other, it is possible to increase the life span of the blades. Furthermore, since it is possible to reduce the number of parts, it is possible to reduce man-hours required to assemble the parts, thereby reducing the manufacturing cost.

In addition, for example, even though the rotary die device 10 is exploded and is then reassembled to replace the blades 21, it is possible to obtain the same assembly accuracy of the rotary die device 10 as that at the time of shipment. Accordingly, it is possible to obtain high reproducibility.

Moreover, the linear bearings 37 are provided between the front plate 33 and the rear plate 34 so that the movable unit 11 can be advanced or retreated. Accordingly, when the movable unit 11 is advanced or retreated with respect to the fixed unit 16 by driving the advance/retreat units 40, the movable unit 11 can slide between the front plate 33 and the rear plate 34 without clearance. As a result, one linear bearing 37 that is mounted to one end of the movable unit 11 in the axial direction thereof, and the other linear bearing 37 that is mounted to the other end of the movable unit 11 in the axial direction thereof can smoothly and equally guide the movable unit 11 so as to be synchronized with each other. For this reason, even though the movable unit 11 slides during the advance or retreat of the movable unit 11, there is no possibility that the axes of the movable unit 11 and the fixed unit 16 are not aligned with each other. Accordingly, it is possible to smoothly adjust the movable unit 11.

In addition, it is possible to obtain the following effects.

For example, since a sanitary product containing hard particles may be used as a workpiece W, there is a possibility that the life span of blades becomes shortened. Accordingly, blades made of a hard metal may be used to prevent the life span of the blades from being shortened.

However, even though blades made of a hard metal are used in the conventional rotary die device, the axes of the movable unit and the fixed unit are not aligned with each other or looseness is generated as described in the related art. For the worse, the blades made of a hard metal can have the same life span as that of blades made of an alloy tool steel or high-speed steel.

Meanwhile, since the rotary die device 10 of the embodiment can be assembled with high accuracy as described above, it is possible to prevent the axes of the fixed unit 16 and the movable unit 11 from not being aligned with each other and to prevent looseness from being generated. Accordingly, even though a product containing hard particles is used as a workpiece, it is possible to increase the life span of the blades depending on the material thereof, thereby improving the reliability of the device.

In addition, the units 40, 11, and 16 are fixed to the supporting structure 30 by the bolts 35. Further, the base plate 31, the top plate 32, the front plate 33, and the rear plate 34 of the supporting structure 30 are provided with insertion holes, into which the bolts 35 are inserted, and the units are provided with internal threads into which the bolts 35 are tightened, in order to fix the units to one another. Accordingly, it is possible to easily tighten the bolts 35. Furthermore, the insertion holes are provided to the base plate 31, the top plate 32, the front plate 33, and the rear plate 34 so that the heads of the bolts 35 are buried in the insertion holes. Accordingly, when the supporting structure 30 is configured, there is no possibility for the bolts 35 to protrude out of the plates so as to be unmanageable.

Meanwhile, the blades 21 are formed on the die 17, which is a roller, of the fixed unit 16 in the embodiment shown in drawings. However, the blades 21 may be formed on the anvil 12, which is a roller, of the movable unit 11. In addition, the rail parts 38 of the linear bearings 37 are mounted to the movable unit 11, and the block parts 39 are mounted on the front and the rear plates 33 and 34. However, the rail parts of the linear bearings may be mounted on the front and the rear plates, and the block parts may be mounted to the movable unit. Furthermore, other actuators may be used instead of the hydraulic cylinders 42 of the advance/retreat units 40.

As described above, according to the first aspect of the invention, the movable unit and the fixed unit come in contact with the rear plate or the front plate by using the inner surface thereof as a reference surface during the assembly, and it is possible to stably fix the units among the rear plate, the front plate, the top plate, and the base plate as well as to stably fix the units between the rear plate and the front plate. Accordingly, it is possible to assemble the entire rotary die device with high accuracy as well as to assemble each unit in the supporting structure with high accuracy, and to obtain very high stiffness. As a result, it is possible to prevent the axes of the fixed unit and the movable unit from being misaligned with each other and remove factors causing vibration by removing looseness. In addition, since it is possible to reduce the number of parts, it is possible to reduce man-hours required to assemble the parts, thereby reducing the manufacturing cost. Furthermore, since it is possible to obtain high reproducibility, it is possible to smoothly cut the workpiece.

According to the second aspect of the invention, when the movable unit is advanced or retreated with respect to the fixed unit by driving the advance/retreat units, the linear bearings, which are mounted on both ends of the movable unit in the axial direction thereof, can smoothly and equally guide the movable unit so as to be synchronized with each other. Accordingly, even though the movable unit is advanced or retreated, there is no possibility of misalignment of the axes of the movable unit and the fixed unit. Therefore, it is possible to smoothly adjust the movable unit.

1. A rotary die device comprising:
a fixed unit and a movable unit each having has a roller and supporters, both ends of the roller being rotatably supported by the supporters, and axes of the fixed unit and movable unit being parallel to each other;
blades formed on one of the rollers of the fixed unit and movable unit; and
a supporting structure supporting the fixed unit and the movable unit;
wherein both rollers of the fixed unit and movable unit are rotated in opposite directions to each other, respectively, so that a workpiece is cut therebetween in a desired shape,
the supporting structure includes a base plate and a top plate which face each other with a predetermined space therebetween, and a front plate and a rear plate which are provided between the base plate and the top plate on the front and rear sides, respectively, and
the fixed unit and the movable unit are fixed between the front plate and the rear plate.

2. The rotary die device according to claim 1, further comprising:
linear bearings that slidably guide the movable unit toward the fixed unit and are provided between the movable unit, and the front plate and the rear plate; and
advance/retreat units that advance or retreat the movable unit with respect to the fixed unit by the linear bearings and are provided between the movable unit, and the front plate and the rear plate.
